(19) United States
(12) Patent Application Publication
(10) Pub. No.: US 2020/0039076 A1
(43) Pub. Date: Feb. 6, 2020

(54) ROBOTIC SYSTEM AND METHOD FOR CONTROL AND MANIPULATION

(71) Applicant: GE Global Sourcing LLC, Norwalk, CT (US)

(72) Inventors: Huan Tan, Niskayuna, NY (US); Balajee Kannan, Niskayuna, NY (US); Yonatan Gefen, Niskayuna, NY (US); Romano Patrick, Atlanta, GA (US); Omar Al Assad, Niskayuna, NY (US); Douglas Forman, Niskayuna, NY (US); Charles Theurer, Alplaus, NY (US); John Lizzi, Niskayuna, NY (US); Bradford Wayne Miller, Niskayuna, NY (US); James D. Brooks, Niskayuna, NY (US); Neeraja Subrahmaniyan, Niskayuna, NY (US)

(21) Appl. No.: 16/596,679

(22) Filed: Oct. 8, 2019

Related U.S. Application Data
(63) Continuation-in-part of application No. 15/293,905, filed on Oct. 14, 2016, now Pat. No. 10,471,595.
Application No. 15/293,905 is a continuation-in-part of application No. 15/061,129, filed on Mar. 4, 2016.
(60) Provisional application No. 62/343,375, filed on May 31, 2016.

(51) Int. Cl. B25J 9/16

(52) U.S. Cl. CPC B25J 9/1697; B25J 9/1664

(57) ABSTRACT

A robotic system is provided that includes a base, an articulable arm, a visual acquisition unit, and a controller. The articulable arm may extend from a base and is movable toward a target. The visual acquisition unit can be mounted to the arm or the base and to acquire image data. The controller is operably coupled to the arm and the visual acquisition unit, and can derive from the image data environmental information corresponding to at least one of the arm or the target. The controller further can generate at least one planning scheme using the environmental information to translate the arm toward the target, select at least one planning scheme for implementation, and control movement of the arm toward the target using the at least one selected planning scheme.

### CROSS-REFERENCE TO RELATED APPLICATIONS

This application is a continuation-in-part and claims priority to U.S. patent application Ser. No. 15/293,905, filed 14 Oct. 2016, which claims priority to U.S. Provisional Application No. 62/343,375, filed 31 May 2016. This application also is a continuation-in-part and claims priority to U.S. patent application Ser. No. 15/061,129, filed 3 Mar. 2016. The entire contents of the foregoing application are incorporated herein by reference.

### BACKGROUND

### Technical Field

This application includes embodiments that relate to robotic systems and methods of control and manipulation.

### Discussion of Art

A variety of tasks may be performed by a robotic system that involve motion of an arm or a portion thereof. For example, a robot arm may be moved to contact or otherwise approach a target. As one example, a lever may be contacted by a robot arm. For instance, in a rail yard on one or more rail vehicle systems within the yard, a robot may be used to contact one or more brake levers. For example, between missions performed by a rail vehicle, various systems, such as braking systems, of the units of a rail vehicle may be inspected and/or tested. As one example, a brake bleeding task may be performed on one or more units of a rail vehicle system. In a rail yard, there may be a large number of rail cars in a relatively confined area, resulting in a large number of inspection and/or maintenance tasks. Conventional manipulation techniques may not provide a desired speed or accuracy in manipulation of a robot arm toward a target.

The robotic system may begin a task outside of the range of the articulatable arm. It may be necessary to move a base that is supporting the arm to be proximate to the target so as to allow the arm to contact it. It may be desirable to have a system and method that differs from those that are currently available.

### BRIEF DESCRIPTION

In one embodiment, robotic system is provided that includes a base, an articulable arm, a visual acquisition unit, and a controller. The articulable arm may extend from a base and is movable toward a target. The visual acquisition unit can be mounted to the arm or the base and to acquire image data. The controller is operably coupled to the arm and the visual acquisition unit, and can derive from the image data environmental information corresponding to at least one of the arm or the target. The controller further can generate at least one planning scheme using the environmental information to translate the arm toward the target, select at least one planning scheme for implementation, and control movement of the arm toward the target using the at least one selected planning scheme.

In one embodiment, a method is provided that includes acquiring image data; deriving environmental information corresponding to at least one of an articulable arm or a target from the image data; generating a planning scheme using the acquired environmental information; and controlling movement of an arm toward a target using the planning scheme;

Optionally, the method may include acquiring additional image data during movement of the arm; generating additional environmental information from the additional image data; re-planning movement of the arm based at least in part on the additional environmental information; and moving a body supporting the arm towards the target based at least in part on the environmental information, the additional environmental information, or both.

In one embodiment, a robotic system is provided that includes an articulable arm extending from a base and configured to be movable toward a target, a visual acquisition unit configured to be mounted to the arm or the base and to acquire image data, and a controller operably coupled to the arm and the visual acquisition unit. The controller can derive from the image data environmental information corresponding to at least one of the arm or the target, generate at least one planning scheme using the environmental information to translate the arm toward the target, wherein each planning scheme is defined by at least one of path shape or path type, select at least one planning scheme for implementation based at least in part on the planning scheme providing movement of the arm in a determined time frame or at a determined speed, and control movement of the arm toward the target using the at least one selected planning scheme.

### BRIEF DESCRIPTION OF THE DRAWINGS

FIG. 1 is a schematic block diagram of a robotic system in accordance with various embodiments;

FIG. 2 is a flowchart of a method for controlling a robotic system in accordance with various embodiments;

FIG. 3 is a schematic diagram of a robotic system in accordance with various embodiments;

FIG. 4 is a schematic illustration of an image analysis system according to one embodiment;

FIG. 5 illustrates one example of image data of a segment of a route;

FIG. 6 illustrates another example of the image data shown in FIG. 5;

FIG. 7 illustrates another example of the image data of the route;

FIG. 8 illustrates another example of the image data of the route;

FIG. 9 illustrates an example of a benchmark visual profile;

FIG. 10 illustrates a visual mapping diagram of image data and a benchmark visual profile according to one example;

FIG. 11 illustrates another view of the visual mapping diagram shown in

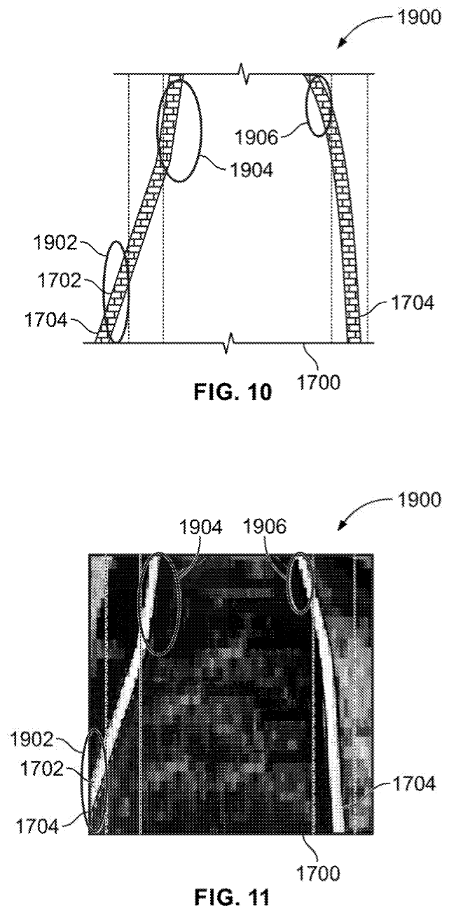

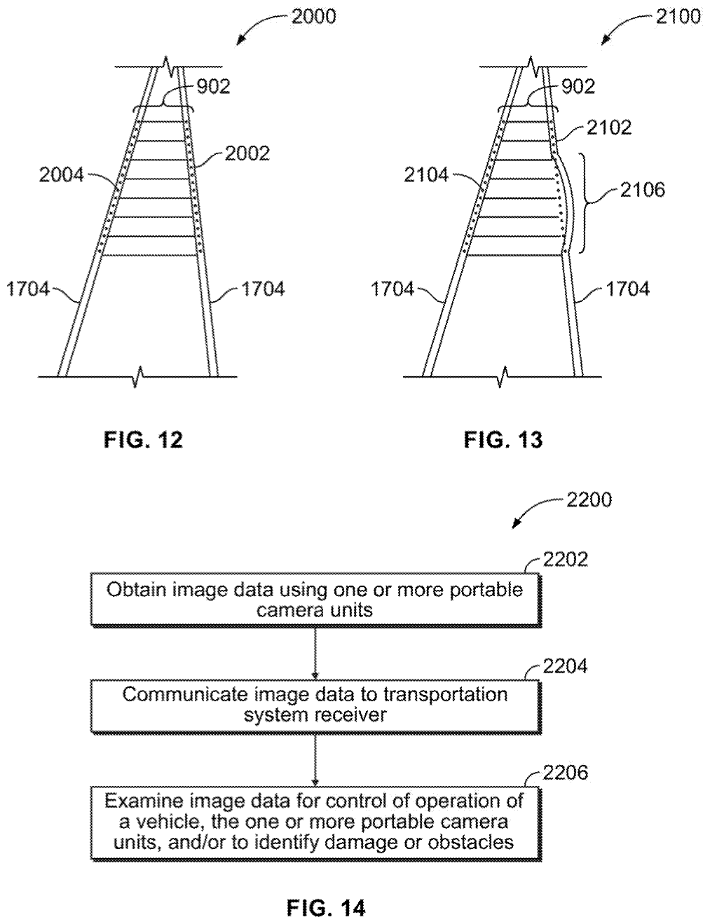

FIG. 10;

FIG. 12 illustrates image data generated onboard and benchmark visual profiles of the route according to another embodiment;

FIG. 13 illustrates other image data with benchmark visual profiles of the route according to another embodiment; and

FIG. 14 illustrates a flowchart of one embodiment of a method for identifying route-related obstacles.

### DETAILED DESCRIPTION

This application includes embodiments that relate to robotic systems and methods of control and manipulation. Various embodiments provide methods and systems for control of robotic systems, including unmanned or remotely controlled vehicles. Unmanned vehicles may be autonomously controlled. For example, various embodiments provide for control of a robotic vehicle to approach and/or contact a target. In some embodiments, the robotic systems may be controlled to contact an object and thereby manipulate that object. In various embodiments, one or more planning schemes may be selected to control motion of an articulable arm using acquired information describing or corresponding to the environment surrounding the articulable arm and/or the target.

At least one technical effect of various embodiments includes improving control (e.g., continuous servo control) reliability, accuracy, and/or precision for robotic systems. At least one technical effect of various embodiments is the improvement of robotic control to account for changes in the environment (e.g., motion of a target, or introduction of an obstacle after an initial movement plan is generated). The robotic system or vehicle may cooperatively engage the articulable arm and the position of the vehicle (via its propulsion system) in order to contact with the target object.

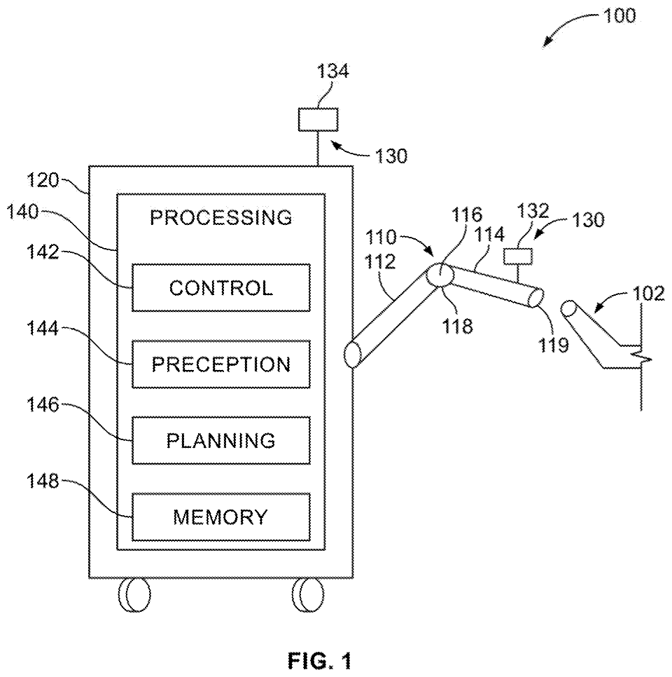

FIG. 1 is a schematic view of a robotic system 100 in accordance with various embodiments. The robotic system depicted in FIG. 1 includes an articulable arm 110, a base 120, a visual acquisition unit or camera 130 and a processing unit or controller. The arm extends from the base and can be moved toward a target 102. For example, in the illustrated embodiment, the target 102 is a lever to be contacted by the arm (or portion of the arm). In some embodiments, the robotic system can be useful in an industrial setting, and as a specific example the robotic system may be deployed in a railyard where the target is a brake lever of a railroad car. Other suitable industrial settings may include a mining operation, on a marine vessel, in a construction site, and the like. The depicted visual acquisition unit can be mounted to the arm or the base. Further, the visual acquisition unit of the illustrated embodiment can acquire environmental information proximate to at least one of the arm or the target. The processing unit may be operably coupled to the arm (e.g., the processing unit sends control signals to the arm to control movement of the arm) and to the visual acquisition unit (e.g., the processing unit receives or obtains the environmental information from the visual acquisition unit). The depicted processing unit may generate an environmental model using the environmental information, select, from a plurality of planning schemes, using the environmental model, at least one planning scheme to translate the arm toward the target, plan movement of the arm toward the target using the selected at least one planning scheme, and control movement of the arm toward the target using the at least one selected planning scheme.

The depicted base, which may be referred to sometimes as a body or platform, may provide a foundation from which the arm extends, and provide a structure for mounting or housing other components, such as the visual acquisition unit (or aspects thereof), the processing unit (or aspects thereof), communication equipment (not shown in FIG. 1), or the like. In various embodiments, the base may have wheels, tracks, or the like, along with a propulsion system (e.g., motor) for mobility. For example, the base may travel from a starting point at a distance too far from the target for the arm to contact the target, with the arm in a retracted or home position while the base is traveling. Once the base is within a range of the target such that the target may be reached by the arm, the arm may be moved to contact the target.

The depicted arm is articulable and can move toward the target (e.g., based upon instructions or control signals from the processing unit). In some embodiments, the arm may be configured only to contact the target or otherwise approach the target (e.g., a camera or sensing device at the end of the arm may be positioned proximate the target for inspection of the target), while in other embodiments the arm may include a manipulation unit (not shown in FIG. 1) that can grasp the target, and manipulate the target (e.g., to grasp and actuate a lever).

As seen in FIG. 1, the example arm of the illustrated embodiment includes a first portion 112 and a second portion 114 joined by a joint 116. The first portion extends from the base and is articulable with respect to the base, and the first portion and second portion are articulable with respect to each other. The motion of the arm (e.g., the first portion and the second portion) may be actuated via associated motors that receive control signals provided by the processing unit. The two portions are shown in the illustrated embodiment for ease of illustration; however, arms having more portions and joints may be utilized in various embodiments. The depicted arm may include a sensor 118 configured to sense or detect position and/or motion of the arm (or portions thereof) at the joint to provide feedback to the processing unit. The depicted arm also includes a sensor 119 disposed at a distal end of the arm. A suitable sensor may be a microswitch that is triggered when the arm (e.g., the distal end of the arm) contacts the target to provide feedback information to the processing unit. Another suitable sensor may include a magnetometer that can sense a presence and/or proximity to ferro metallic material.

As discussed, the visual acquisition unit can acquire environmental information corresponding to at least one of the arm, the target and the route from a point at the present location to a point proximate or adjacent to the target. For example, the environmental information may include information describing, depicting, or corresponding to the environment surrounding the arm, such as a volume sufficient to describe the environment within reach of the arm. In various embodiments, the perception acquisition unit 132 may include one or more of a camera, stereo camera, or laser sensor. For example, the visual acquisition unit may include on or more motion sensors, such as a Kinect motion sensor. The visual acquisition unit in various embodiments includes an infrared projector and a camera.

More than one individual device or sensor may be included in the depicted visual acquisition unit. For example, in the illustrated embodiment, the robotic system includes an arm-mounted visual acquisition unit 132 and a base-mounted visual acquisition unit 134. In some embodiments, the base-mounted visual acquisition unit 134 may be used to acquire initial environmental information (e.g., with the robotic system en route to the target, and/or when the arm is in a retracted position), and the arm-mounted visual acquisition unit 132 may obtain additional environmental information (e.g., during motion of the arm and/or when the arm is near the target) which may be used by the processing unit to dynamically re-plan movement of the arm, for example, to account for any motion by the target, or, as another example, to account for any obstacles that have moved into the path between the arm and the target.

The processing unit can generate an environmental model using the environmental information. The environmental information includes information describing, depicting, or corresponding to the environment surrounding the arm and/or the target, which may be used to determine or plan a path from the arm to the target that may be followed by the arm. In some embodiments, the desired movement is a movement of the arm (e.g., a distal portion of the arm) toward a target such as a brake lever, or other motion in which the arm is moving toward the target. In some embodiments, a grid-based algorithm may be utilized to model an environment (e.g., where the arm will move through at least a portion of the environment to touch the target 102). The environmental information may identify the target (e.g., based on a known size, shape, and/or other feature distinguishing the target from other aspects of the environment).

In some embodiments, the environmental information may be collected using Kinect or the like. In various embodiments, point cloud data points may be collected and grouped into a grid, such as an OctoMap grid or a grid formed using another three-dimensional (3D) mapping framework. The particular size and resolution of the grid is selected in various embodiments based on the size of the target, the nearness of the target to the arm, and/or the available computational resources, for example. For example, a larger grid volume may be used for an arm that has a relatively long reach or range, and a smaller grid volume may be used for an arm that has a relatively short reach or range, or when the arm is near the target. As another example, smaller grid cubes may be used for improved resolution, and larger grid cubes used for reduced computational requirements. In an example embodiment, where the robotic system can touch a brake lever with the arm, and where the arm has a range of 2.5 meters, the environmental model may be modeled as a sphere with a radius of 2.5 meters with cubes sized 10 centimeters×10 centimeters×10 centimeters. The sphere defining the volume of the environmental model may in various embodiments be centered around the target, around a distal end of the arm, around a visual acquisition unit (e.g., arm-mounted visual acquisition unit 132, base-mounted visual acquisition unit 134), and/or an intermediate point, for example, between a distal end of the arm and the target.

The depicted processing unit is also configured to select, from a plurality of planning schemes, at least one planning scheme to translate the arm toward the target. The processing unit uses the environmental model to select the at least one planning scheme. For example, using the relative location of the target and the arm (i.e., a portion of the arm configured to touch the target), as well as the location of any identified obstacles between the arm and the target, a path may be selected between the arm contact portion and the target. Depending on the shape of the path and/or complexity (e.g., the number and/or location of obstacles to be avoided), a planning scheme may be selected. As used herein, a planning scheme is a plan that sets forth a trajectory or path of the arm along a shape (or shapes) of a path as defined by a determined coordinate system. Accordingly, in various embodiments, each planning scheme of the plurality of schemes is defined by path shape or type and a coordinate system. In various embodiments, the at least one planning scheme may be selected to reduce or minimize time of motion and/or computational requirements while providing sufficient complexity to avoid any obstacles between the arm and the target. Generally, a motion planning scheme or algorithm is selected in various embodiments to provide for movement of the arm within a desired time frame or at a desired speed.

In various embodiments, the processing unit may select among a group of planning schemes that include at least one planning scheme that uses a first coordinate system and at least one other planning scheme that uses a second coordinate system (where the second coordinate system is different than the first coordinate system). For example, at least one planning scheme may utilize a Cartesian coordinate system, while at least one other planning scheme may utilize a joint space coordinate system.

As one example, the group of planning schemes may include a first planning scheme that utilizes linear trajectory planning in a joint space coordinate system. For example, a starting position and a target position for a motion may be defined. Then, using an artificial potential field algorithm, way points on the desired motion may be found. In this planning scheme, the motion is linear in the joint space (e.g., in 6 degrees of freedom of a robot arm), but non-linear in Cartesian space. After the way points are determined, velocities may be assigned to each way point depending on the task requirements. In some embodiment, the arm may be directed toward a lever that is defined in terms of 6D poses in Cartesian space. After obtaining the 6D poses in Cartesian space, the 6D pose in Cartesian space may be converted to 6 joint angles in joint space using inverse kinematics. With the joint angles determined, the desired joint angles on the motion trajectory may be determined. The first planning scheme as discussed herein (utilizing linear trajectory planning in a joint space coordinate system) may be particularly useful in various embodiments for motion in an open space, providing for relatively fast and/or easy planning in open space.

As another example, the group of planning schemes may include a second planning scheme that utilizes linear trajectory planning in a Cartesian coordinate system. For example, an artificial potential field algorithm may be used to fin way points on a desire motion trajectory in Cartesian space. Then, using inverse kinematics, corresponding way point in joint space may be found, with velocities to the way points assigned to implement the control. The second planning scheme as discussed herein (utilizing linear trajectory planning in a Cartesian coordinate system) may be particularly useful in various embodiments for motion in less open space, and/or for providing motion that may be more intuitive for a human operator working in conjunction with the robotic system.

As yet another example, the group of planning schemes may include a third planning scheme that utilizes point-to-point trajectory planning in a joint space coordinate system. In this planning scheme, target joint angles (e.g., joint angles of the portions of the arm at a beginning and end of a movement) may be defined with any internal way points. The third planning scheme as discussed herein (utilizing point-to-point trajectory planning in a joint space coordinate system) may be particularly useful in various embodiments for homing or re-setting, or to bring the arm to a target position (e.g., to a retracted or home position, or to the target) as quickly as possible.

Paths other than linear or point-to-point may be used. For example, a circular path (e.g., a path following a half-circle or other portion of a circle in Cartesian space) may be specified or utilized. As another example, a curved path may be employed. As another example, for instance to closely track a known surface profile, a path corresponding to a polygon or portion thereof may be employed, such as triangular or diamond shape.

More than one planning scheme may be employed for the movement from an initial position to the target. For example, a first planning scheme may be used to plan motion for a first portion of a motion, and a different planning scheme may be used to plan motion for a second portion of the motion. Accordingly, the processing unit in various embodiments control movement of the arm in a series of stages, with a first planning scheme used for at least one of the stages and a second, different planning scheme used for at least one other stage. In one example scenario, the first planning scheme described above may be used for an initial portion of the motion toward the target, for example in an open space or over a volume where precision may not be required. Then, for a portion of the motion closer to the target, the second planning scheme described above may be used for the motion toward the target. Finally, the third planning scheme described above may be used to retract the arm from the target and to a retracted or home position. Other combinations or arrangements of sequences of planning schemes used for a combined overall movement may be employed in various embodiments. Accordingly, the processing unit may select not only particular planning schemes to be used, but also sequences of planning schemes and transition points between the sequences of planning schemes for planning an overall motion.

Also, the processing unit of the illustrated example can plan movement of the arm toward the target using the selected at least one planning scheme. After the planning scheme (or sequence of planning schemes) has been selected, the depicted processing unit plans the motion. For example, a series of commands to control the motion of the arm (e.g., to move the joints of the arms through a series of predetermined angular changes at predetermined corresponding velocities) may be prepared. For example, for an arm that has multiple portions, the generated motion trajectories may be defined as a sequence of way points in joint space. Each way point in some embodiments includes information for 7 joint angles, velocity, and a timing stamp. The joint angles, timing stamp, and velocity may be put in a vector of points, and a command sent to drive the arm along the desired motion trajectory. For example, a program such as MotoROS may be run on the robotic system to implement the planned motion and commanded movement. Accordingly, the depicted processing unit controls movement of the arm toward the target using the at least one selected planning scheme.

The planning and motion of the arm may be adjusted in various embodiments. For example, processing unit may control the visual acquisition unit or portion thereof (e.g., arm-mounted visual acquisition unit 132) to acquire additional environmental information during movement of the arm (e.g., during movement of the arm toward the target). The processing unit may then dynamically re-plan movement of the arm (e.g., during movement of the arm) using the additional environmental information. For example, due to motion of the target during movement of the arm, a previously used motion plan and/or planning scheme used to generate the motion plan may no longer be appropriate, or a better planning scheme may be available to address the new position of the target. Accordingly, the processing unit in various embodiments uses the additional environmental information obtained during motion of the arm to re-plan the motion using an initially utilized planning scheme and/or re-plans the motion using a different planning scheme.

For example, the processing unit may use a first planning scheme for an initial planned movement using the environmental information (e.g., originally or initially obtained environmental information acquired before motion of the arm), and use a different, second planning scheme for revised planned movement using additional environmental information (e.g., environmental information obtain during movement of the arm or after an initial movement of the arm). For example, a first planning scheme may plan a motion to an intermediate point short of the target at which the arm stops, additional environmental information acquired, and the remaining motion toward the target may be planned using a second planning scheme. As another example, a first planning scheme may be used to plan an original motion; however, an obstacle may be discovered during movement, or the target may be determined to move during the motion of the arm, and a second planning scheme used to re-plan the motion. For instance, in one example scenario, an initial motion is planned using a point-to-point in joint space planning scheme. However, an obstacle may be discovered while the arm is in motion, and the motion may be re-planned using linear trajectory planning in Cartesian space to avoid the obstacle. In some embodiments, the re-planned motion in Cartesian space may be displayed to an operator for approval or modification.

As discussed herein, the depicted processing unit is operably coupled to the arm and the visual acquisition unit. For example, the processing unit may provide control signals to and receive feedback signals from the arm, and may receive information (e.g., environmental information regarding the positioning of the target, the arm, and/or other aspects of an environment proximate to the arm and/or target) from the visual acquisition unit. In the illustrated embodiment, the processing unit is disposed onboard the robotic system (e.g., on-board the base); however, in some embodiments the processing unit or a portion thereof may be located off-board. For example, all or a portion of the robotic system may be controlled wirelessly by a remotely located processor (or processors). The processing unit may be operably coupled to an input unit (not shown) configured to allow an operator to provide information to the robotic system, for example to identify or describe a task to be performed.

The depicted processing unit includes a control module 142, a perception module 144, a planning module 146, and a memory 148. Arrangements of units or sub-units of the processing unit may be employed in various embodiments, and that other types, numbers, or combinations of modules may be employed in alternate embodiments, and/or various aspects of modules described herein may be utilized in connection with different modules additionally or alternatively based at least in part on application specific criteria. The various aspects of the processing unit act individually or cooperatively with other aspects to perform one or more aspects of the methods, steps, or processes discussed herein. The processing unit may include processing circuitry configured to perform one or more tasks, functions, or steps discussed herein. The term processing unit is not intended to necessarily be limited to a single processor or computer. For example, the processing unit may include multiple processors and/or computers, which may be integrated in a common housing or unit, or which may be distributed among various units or housings.

The depicted control module may use inputs from the planning module to control movement of the arm the control module can provide control signals to the arm (e.g., to one or more motors or other actuators associated with one or more portions of the arm). The depicted perception module can acquire environmental information from the visual acquisition unit, and to generate an environmental model using the environmental information as discussed herein. The perception module in the illustrated embodiment provides information to the planning module for use in planning motion of the arm. The depicted planning module can select one or more planning schemes for planning motion of the arm as discussed herein. After selection of one or more planning schemes, the depicted planning module plans the motion of the arm using the one or more planning schemes and provides the planned motion to the control module for implementation.

The memory may include one or more tangible and non-transitory computer readable storage media. The memory, for example, may be used to store information corresponding to a task to be performed, a target, control information (e.g., planned motions), or the like. Also, the memory may store the various planning schemes from which the planning module develops a motion plan. Further, the process flows and/or flowcharts discussed herein (or aspects thereof) may represent one or more sets of instructions that are stored in the memory for direction of operations of the robotic system.

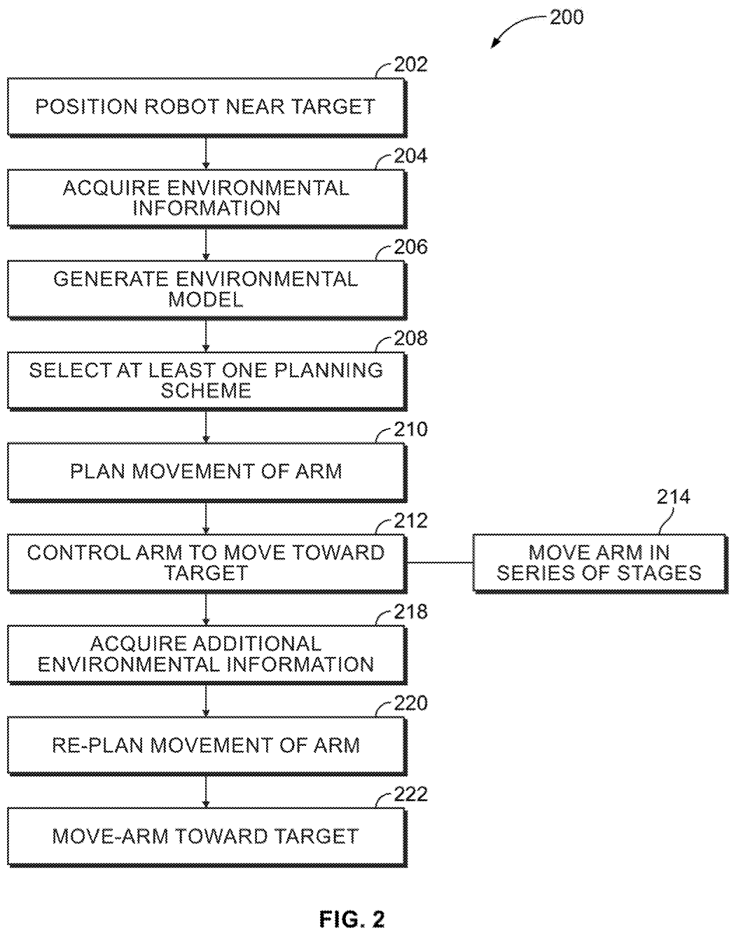

FIG. 2 provides a flowchart of a method 200 for controlling a robot, for example a robot having an arm to be extended toward a target. In various embodiments, the method 200, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 200 may be able to be used as one or more algorithms to direct hardware to perform operations described herein.

At 202, a robot (e.g., autonomous vehicle or robotic system 300) may be positioned near a target (e.g., target). The target, for example, may be a switch to be contacted by the robot. The robot may be configured to manipulate the target or a portion thereof after being place in contact with or proximate the target. The robot may include an arm configured to extend toward the target. In the illustrated embodiment, the robot at 202 is positioned within a range of the target defined by the reach of the arm of the robot.

At 204, environmental information is acquired. In various embodiments, the environmental information is acquired with a visual acquisition unit (e.g., visual acquisition unit, arm-mounted visual acquisition unit 132, base-mounted visual acquisition unit 134). The environmental information corresponds to at least one of the arm or the target to which the arm can be moved toward. For example, the environmental information may describe or correspond to a volume that includes the target and an arm (or portion thereof, such as a distal end) as well as any objected interposed between the arm and target or otherwise potentially contacted by a motion of the arm toward the object.

At 206, an environmental model may be generated using the environmental information acquired at 204. The environmental model, for example, may be composed of a grid of uniform cubes forming a sphere-like volume.

At 208, at least one planning scheme is selected. The at least one planning scheme can be used to plan a motion of the arm toward the target and may be selected in the illustrated embodiment using the environmental model. A planning scheme may be defined by a path type or shape (e.g., linear, point-to-point) and a coordinate system (e.g., Cartesian, joint space). In various embodiments the at least one planning scheme is selected from among a group of planning schemes including a first planning scheme that utilizes a first coordinate system (e.g., a Cartesian coordinate system) and a second planning scheme that utilizes a different coordinate system (e.g., a joint space coordinate system). In various embodiments, the selected at least one planning scheme includes a sequence of planning schemes, with each planning scheme in the sequence used to plan movement for a particular portion or segment of the motion toward the target.

At 210, movement of the arm is planned. The movement of the arm is planned using the planning scheme (or sequence of planning schemes) selected at 208. At 212, the arm is controlled to move toward the object. The arm is controlled using the plan developed at 210 using the at least one scheme selected at 208.

In the illustrated embodiment, at 214, the arm is moved in a series of stages. In some embodiments, the selected planning schemes include a first planning scheme that is used for at least one of the stages and a different, second planning scheme that is used for at least one other of the stages.

In the depicted embodiment, as the arm is moved toward the target (e.g., during actual motion of the arm and/or during a pause in motion after an initial movement toward the target), at 216, additional environmental information is acquired. For example, a visual acquisition unit (e.g., arm-based visual acquisition unit 132) is controlled to acquire additional environmental information. The additional environmental information may, for example, confirm a previously used position of the target, correct an error in a previous estimate of position of the target, or provide additional information regarding movement of the target.

At 218, movement of the arm is dynamically re-planned using the additional information. As one example, if the target has moved, the movement of the arm may be re-planned to account for the change in target location. In some embodiments, the same planning scheme used for an initial or previous motion plan may be used for the re-plan, while in other embodiments a different planning scheme may be used. For example, a first planning scheme may be used for an initial planned movement using environmental information acquired at 204, and a second, different planning scheme may be used for revised planned movement using the additional environmental information acquired 216. At 220, the arm is moved toward the target using the re-planned movement. While only one re-plan is shown in the illustrated embodiment, additional re-plans may be performed in various embodiments. Re-plans may be performed at planned or regular intervals, and/or responsive to detection of movement of the target and/or detection of a previously unidentified obstacle in or near the path between the arm and the target.

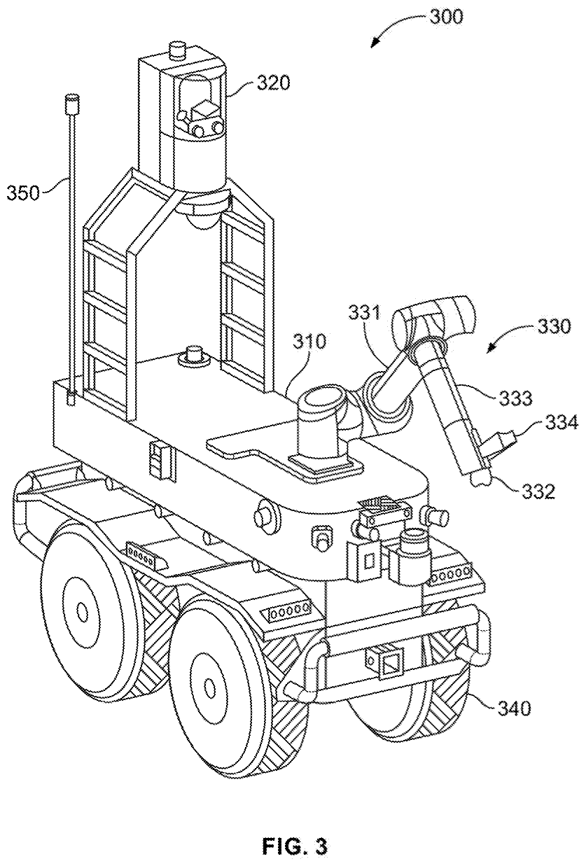

FIG. 3 provides a perspective view of a robotic system 300 formed in accordance with various embodiments. The robotic system may be useful as a rail yard robot. The robotic system may include one or more aspects generally similar to the robotic system discussed in connection with FIG. 1, and in various embodiments can perform one or more tasks as described in connection with FIG. 1 and/or FIG. 2. The depicted robotic system includes a body (or base) 310. The body, for example, may house one or more processors (e.g., one or more processors that form all or a portion of the processing unit). The body may provide for the mounting of other components and/or sub-systems.

In the illustrated embodiment, the robotic system includes a base-mounted visual acquisition unit 320 mounted to the body 310. The depicted articulated arm 330 includes plural jointed sections 331, 333 interposed between a distal end 332 and the body 310. The distal end 332 is configured for contact with a target. In some embodiments, a gripper or other manipulator (not shown in FIG. 3) is disposed proximate the distal end 332. An arm-mounted visual acquisition unit 334 is also disposed on the arm 330. The base-mounted visual acquisition unit 320 and/or the arm-mounted visual acquisition unit 334 may be used to acquire environmental information as discussed herein.

The robotic system or vehicle includes wheels 340 that can be driven by a motor and/or steered to move the robotic system about an area (e.g., a rail yard) when the robotic system is in a navigation mode. Additionally or alternatively, tracks, legs, or other mechanisms may be utilized to propel or move the robotic system. In the illustrated embodiment, the antenna 350 may be used to communicate with a base, other robots, or the like.

The particular arrangement of components (e.g., the number, types, placement, or the like) of the illustrated embodiments may be modified in various alternate embodiments. For example, in various embodiments, different numbers of a given module or unit may be employed, a different type or types of a given module or unit may be employed, a number of modules or units (or aspects thereof) may be combined, a given module or unit may be divided into plural modules (or sub-modules) or units (or sub-units), one or more aspects of one or more modules may be shared between modules, a given module or unit may be added, or a given module or unit may be omitted.

In one embodiment, the robotic system may include a propulsion unit that can move the robotic system between different locations, and/or a communication unit configured to allow the robotic system to communicate with a remote user, a central scheduling or dispatching system, or other robotic systems, among others. A suitable arm may be a manipulation device or other tool in one embodiment. In another embodiment, the arm may be a scoop on a backhoe or excavation equipment.

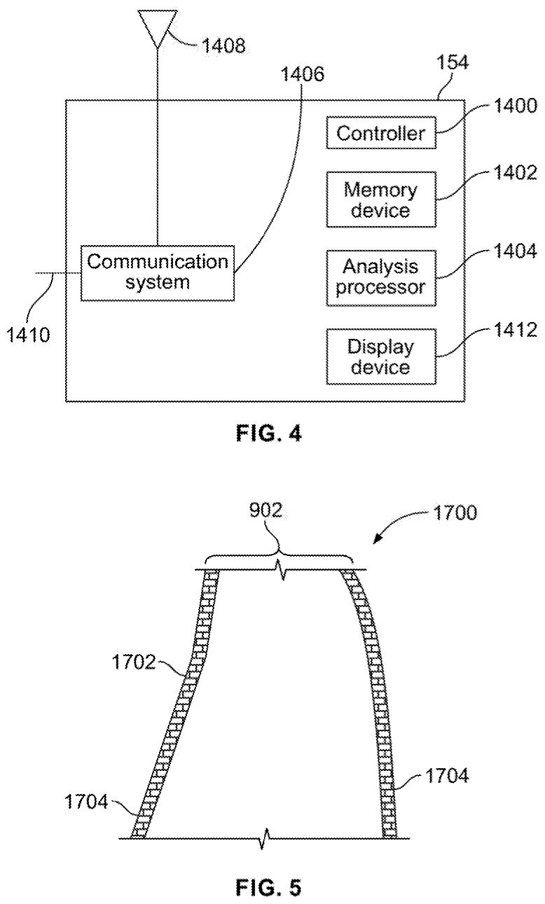

FIG. 4 is a schematic illustration of the image analysis system 154 according to one embodiment that may be used to propel the robotic system or vehicle described with respect to FIG. 3 to a target. An image analysis system (not shown) can examine data content of image data to automatically identify objects in the image data, damage in the route, obstacles or barriers, and the like. A controller 1400 of the system includes or represents hardware circuits or circuitry that includes and/or is connected with one or more computer processors, such as the image analysis system. The controller can save image data obtained by a visual acquisition device to one or more memory devices 1402 of the imaging system, generate alarm signals responsive to identifying one or more problems with the route and/or the wayside devices based on the image data that is obtained, or the like. The memory device includes one or more computer readable media used to at least temporarily store the image data. A suitable memory device can include a computer hard drive, flash or solid state drive, optical disk, or the like.

During travel of a robotic system along a route towards a target, in one embodiment, the visual acquisition device can generate image data representative of images and/or video of the field of view of the visual acquisition device(s). For example, the image data may be used to inspect the health of the route, status of wayside devices along the route being traveled on by the robotic system, or the like. The field of view of the visual acquisition device can encompass at least some of the route and/or wayside devices disposed ahead of the robotic system along a direction of travel of the robotic system. During movement of the robotic system along the route, the visual acquisition device can obtain image data representative of the route and/or the wayside devices for examination to determine if the route and/or wayside devices are functioning properly, are in the proper operational state, or have been damaged and need repair, and/or need manipulation or further examination.

The image data created by the visual acquisition device can be referred to as machine vision, as the image data represents what is seen by the system in the field of view of the visual acquisition device. The image data may constitute environmental information. One or more analysis processors 1404 of the system may examine the image data to identify conditions of the robotic system, the route, the target, and/or wayside devices. Optionally, the analysis processor can examine the terrain at, near, or surrounding the route and/or wayside devices to determine if the terrain has changed such that maintenance of the route, wayside devices, and/or terrain is needed. For example, the analysis processor can examine the image data to determine if vegetation (e.g., trees, vines, bushes, and the like) is growing over the route or a wayside device (such as a signal) such that travel over the route may be impeded and/or view of the wayside device may be obscured from an operator of the robotic system. The analysis processor can represent hardware circuits and/or circuitry that include and/or are connected with one or more processors, such as one or more computer microprocessors, controllers, or the like.

As another example, the analysis processor can examine the image data to determine if the terrain has eroded away from, onto, or toward the route and/or wayside device such that the eroded terrain is interfering with travel over the route, is interfering with operations of the wayside device, or poses a risk of interfering with operation of the route and/or wayside device. Thus, the terrain “near” the route and/or wayside device may include the terrain that is within the field of view of the visual acquisition device when the route and/or wayside device is within the field of view of the visual acquisition device, the terrain that encroaches onto or is disposed beneath the route and/or wayside device, and/or the terrain that is within a designated distance from the route and/or wayside device (e.g., two meters, five meters, ten meters, or another distance).

Acquisition of image data from the visual acquisition device can allow for the analysis processor 1404 to have access to sufficient information to examine individual video frames, individual still images, several video frames, or the like, and determine the condition of the route, the wayside devices, and/or terrain at or near the wayside device. The image data optionally can allow for the analysis processor to have access to sufficient information to examine individual video frames, individual still images, several video frames, or the like, and determine the condition of the route. The condition of the route can represent the health of the route, such as a state of damage to one or more rails of a track, the presence of foreign objects on the route, overgrowth of vegetation onto the route, and the like. As used herein, the term “damage” can include physical damage to the route (e.g., a break in the route, pitting of the route, or the like), movement of the route from a prior or designated location, growth of vegetation toward and/or onto the route, deterioration in the supporting material (e.g., ballast material) beneath the route, or the like. For example, the analysis processor may examine the image data to determine if one or more rails are bent, twisted, broken, or otherwise damaged. Optionally, the analysis processor can measure distances between the rails to determine if the spacing between the rails differs from a designated distance (e.g., a gauge or other measurement of the route). The analysis of the image data by the analysis processor can be performed using one or more image and/or video processing algorithms, such as edge detection, pixel metrics, comparisons to benchmark images, object detection, gradient determination, or the like.

A communication system 1406 of the system represents hardware circuits or circuitry that include and/or are connected with one or more processors (e.g., microprocessors, controllers, or the like) and communication devices (e.g., wireless antenna 1408 and/or wired connections 1410) that operate as transmitters and/or transceivers for communicating signals with one or more locations. For example the communication system may wirelessly communicate signals via the antenna and/or communicate the signals over the wired connection (e.g., a cable, bus, or wire such as a multiple unit cable, train line, or the like) to a facility and/or another vehicle system, or the like.

The image analysis system optionally may examine the image data obtained by the visual acquisition device to identify features of interest and/or designated targets or objects in the image data. By way of example, the features of interest can include gauge distances between two or more portions of the route. With respect to automobiles, the features of interest may include roadway markings. With respect to mining equipment, the features of interest may be ruts or hardscrabble pathways. With respect to rail vehicles, the features of interest that are identified from the image data can include gauge distances between rails of the route. The designated objects can include wayside assets, such as safety equipment, signs, signals, switches, inspection equipment, or the like. The image data can be inspected automatically by the route examination systems to determine changes in the features of interest, designated objects that are missing, designated objects that are damaged or malfunctioning, and/or to determine locations of the designated objects. This automatic inspection may be performed without operator intervention. Alternatively, the automatic inspection may be performed with the aid and/or at the request of an operator.

The image analysis system can use analysis of the image data to detect the route. The robotic system can be alerted to implement one or more responsive actions for obstacles, such as by slowing down and/or stopping the robotic system. When an obstacle is identified, one or more other responsive actions may be initiated. For example, a warning signal may be communicated (e.g., transmitted or broadcast) to one or more other robotic systems to warn the other robotic systems, a warning signal may be communicated to one or more wayside devices disposed at or near the route so that the wayside devices can communicate the warning signals to one or more other robotic systems, a warning signal can be communicated to an off-board facility that can arrange for the repair and/or further examination of the route, or the like.

In another embodiment, the image analysis system can examine the image data to identify text, signs, or the like, along the route. For example, information printed or displayed on signs, display devices, indicators from other robotic systems, and the like. These may indicate speed limits, locations, warnings, upcoming obstacles, identities of other robotic systems, or the like, and may be autonomously read by the image analysis system. The image analysis system can identify information by the detection and reading of information on signs. In one aspect, the image analysis processor can detect information (e.g., text, images, or the like) based on intensities of pixels in the image data, based on wireframe model data generated based on the image data, or the like. The image analysis processor can identify the information and store the information in the memory device. The image analysis processor can examine the information, such as by using optical character recognition to identify the letters, numbers, symbols, or the like, that are included in the image data. This information may be used to autonomously and/or remotely control the robotic system, such as by communicating a warning signal to the control unit of a robotic system, which can slow the robotic system in response to reading a sign that indicates a speed limit that is slower than a current actual speed of the robotic system. As another example, this information may be used to identify the robotic system and/or cargo carried by the robotic system by reading the information printed or displayed on the robotic system.

In another example, the image analysis system can examine the image data to ensure that safety equipment on the route is functioning as intended or designed. For example, the image analysis processor, can analyze image data that shows crossing equipment. The image analysis processor can examine this data to determine if the crossing equipment is functioning to notify other robotic systems at a crossing (e.g., an intersection between the route and another route, such as a road for automobiles) of the passage of the robotic system through the crossing.

In another example, the image analysis system can examine the image data to predict when repair or maintenance of one or more objects shown in the image data is needed. For example, a history of the image data can be inspected to determine if the object exhibits a pattern of degradation over time. Based on this pattern, a services team (e.g., a group of one or more personnel and/or equipment) can identify which portions of the object are trending toward a bad condition or already are in bad condition, and then may proactively perform repair and/or maintenance on those portions of the object. The image data from multiple different visual acquisition devices acquired at different times of the same objects can be examined to determine changes in the condition of the object. The image data obtained at different times of the same object can be examined in order to filter out external factors or conditions, such as the impact of precipitation (e.g., rain, snow, ice, or the like) on the appearance of the object, from examination of the object. This can be performed by converting the image data into wireframe model data.

In one aspect, the analysis processor of the image analysis system can examine and compare image data acquired by visual acquisition devices to detect hazards and obstacles ahead of the robotic system, such as obstacles in front of the robotic system along the route, detect damaged segments of the route, identify the target, identify a path to the target, and the like. For example, robotic system can include a forward-facing visual acquisition device that generates image data representative of a field of view ahead of the robotic system along the direction of travel 1600, a sideways-facing visual acquisition device that generates image data representative of a field of view around the robotic system, and a rearward-facing camera that generates image data representative of a field of view behind the robotic system (e.g., opposite to the direction of travel of the robotic system). The robotic system optionally may include two or more visual acquisition devices, such as forward-facing, downward-facing, and/or rearward-facing visual acquisition devices that generate image data. Multi-camera systems may be useful in generating depth sensitive imagery and 3D models.

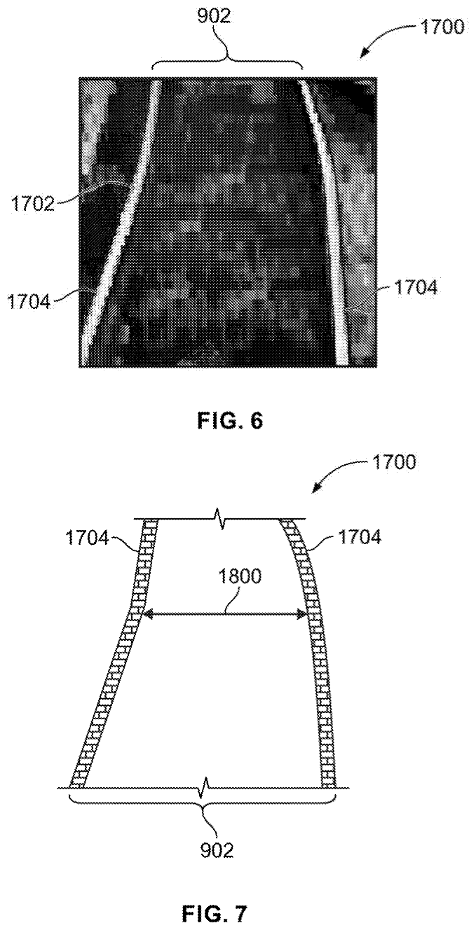

In one embodiment, the image data from the various visual acquisition devices can be compared to benchmark visual profiles of the route by the image analysis processor to detect obstacles on the route, damage to the route (e.g., breaks and/or bending in rails of the route), or other hazards. FIGS. 6 and 7 illustrate one example of image data 1700 of a segment of a route 902. As shown in FIGS. 6 and 7, the image data may be a digital image formed from several pixels 1702 of varying color and/or intensity. Pixels with greater intensities may be lighter in color (e.g., whiter) while pixels with lesser intensities may be darker in color. In one aspect, the image analysis processor examines the intensities of the pixels to determine which portions of the image data represent the route (e.g., rails 1704 of a track, edges of a road, or the like). For example, the processor may select those pixels having intensities that are greater than a designated threshold, the pixels having intensities that are greater than an average or median of several or all pixels in the image data, or other pixels as representing locations of the route. Alternatively, the processor may use another technique to identify the route in the image.

The image analysis processor can select one or more benchmark visual profiles from among several such profiles stored in a computer readable memory, such as the memory device. The memory device can include or represent one or more memory devices, such as a computer hard drive, a CD-ROM, DVD ROM, a removable flash memory card, a magnetic tape, or the like. The memory device can store the image data obtained by the visual acquisition devices and the benchmark visual profiles associated with a trip of the robotic system.

The benchmark visual profiles represent designated layouts of the route that the route is to have at different locations. For example, the benchmark visual profiles can represent the positions, arrangements, relative locations, of rails or opposite edges of the route when the rails or route were installed, repaired, last passed an inspection, or otherwise.

In one aspect, a benchmark visual profile is a designated gauge (e.g., distance between rails of a track, width of a road, or the like) of the route. Alternatively, a benchmark visual profile can be a previous image of the route at a selected location. In another example, a benchmark visual profile can be a definition of where the route is expected to be located in an image of the route. For example, different benchmark visual profiles can represent different shapes of the rails or edges of a road at different locations along a trip of the robotic system from one location to another.

The processor can determine which benchmark visual profile to select in the memory device based on a location of the robotic system when the image data is obtained by visual acquisition devices disposed onboard the robotic system. The processor can select the benchmark visual profile from the memory device that is associated with and represents a designated layout or arrangement of the route at the location of the robotic system when the image data is obtained. This designated layout or arrangement can represent the shape, spacing, arrangement, or the like, that the route is to have for safe travel of the robotic system. For example, the benchmark visual profile can represent the gauge and alignment of the rails of the track when the track was installed or last inspected.

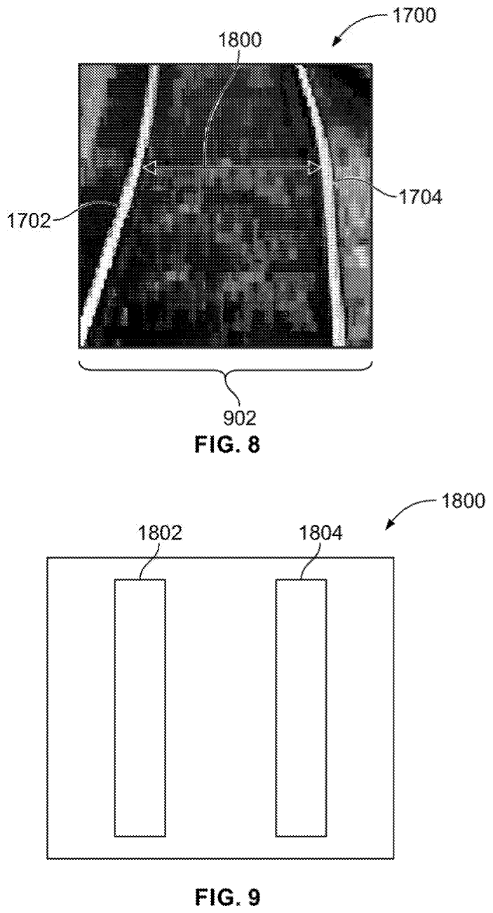

In one aspect, the image analysis processor can measure a gauge of the segment of the route shown in the image data to determine if the route is misaligned. FIGS. 7 and 8 illustrate another example of the image data of the route. The image analysis processor can examine the image data to measure a gauge distance 1800 between the rails of the route, between opposite sides or edges of the route, or the like. Optionally, the gauge distance can represent a geometric dimension of the route, such as a width of the route, a height of the route, a profile of the route, a radius of curvature of the route, or the like.

The image analysis processor can measure a straight line or linear distance between one or more pixels in the image data that are identified as representing one rail, side, edge, or other component of the route to one or more other pixels identified as representing another rail, side, edge, or other component of the route, as shown in FIGS. 7 and 8. This distance can represent a gauge distance of the route. Alternatively, the distance between other pixels may be measured. The image analysis processor can determine the gauge distance by multiplying the number of pixels between the rails, edges, sides, or other components of the route by a known distance that the width of each pixel represents in the image data, by converting the number of pixels in the gauge distance to length (e.g., in centimeters, meters, or the like) using a known conversion factor, by modifying a scale of the gauge distance shown in the image data by a scaling factor, or otherwise. In one aspect, the image analysis processor can convert the image data to or generate the image data as wireframe model data, as described in the '294 application. The gauge distances may be measured between the portions of the wireframe model data that represent the rails.

The measured gauge distance can be compared to a designated gauge distance stored in the memory device onboard the robotic system (or elsewhere) for the imaged section of the route. The designated gauge distance can be a benchmark visual profile of the route, as this distance represents a designated arrangement or spacing of the rails, sides, edges, or the like, of the route. If the measured gauge distance differs from the designated gauge distance by more than a designated threshold or tolerance, then the image analysis processor can determine that the segment of the route that is shown in the image data is misaligned. For example, the designated gauge distance can represent the distance or gauge of the route when the rails of a track were installed or last passed an inspection. If the measured gauge distance deviates too much from this designated gauge distance, then this deviation can represent a changing or modified gauge distance of the route.

Optionally, the image analysis processor may determine the gauge distance several times as the robotic system travels over the route, and monitor the measured gauge distances for changes. If the gauge distances change by more than a designated amount, then the image analysis processor can identify the upcoming segment of the route as being potentially misaligned. As described below, however, the change in the measured gauge distance alternatively may represent a switch in the route that the robotic system is traveling toward.

Measuring the gauge distances of the route can allow the image analysis processor to determine when one or more of the rails in the route are misaligned, even when the segment of the route includes a curve. Because the gauge distance should be constant or substantially constant (e.g., within manufacturing tolerances, such as where the gauge distances do not vary by more than 1%, 3%, 5%, or another value), the gauge distance should not significantly change in curved or straight sections of the route, unless the route is misaligned.

In one embodiment, the image analysis processor can track the gauge distances to determine if the gauge distances exhibit designated trends within a designated distance and/or amount of time. For example, if the gauge distances increase over at least a first designated time period or distance and then decrease over at least a second designated time period, or decrease over at least the first designated time period or distance and then increase over a least the second designated time period, then the image analysis processor may determine that the rails are misaligned. Optionally, the image analysis processor may determine that the rails are misaligned responsive to the gauge distances increasing then decreasing, or decreasing then increasing, as described above, within a designated detection time or distance limit.

FIG. 9 illustrates an example of a benchmark visual profile. The benchmark visual profile represents a designated layout of the route, such as where the route is expected to be in the image data obtained by one or more of the visual acquisition devices disposed onboard the robotic system. In the illustrated example, the benchmark visual profile includes two designated areas 1802, 1804 that represent designated positions of rails of a track, edges or sides of a route, or other components of the route. The designated areas can represent where the pixels of the image data that represent the rails, edges, sides, or the like, of the route should be located if the rails, edges, sides, or the like, are aligned properly. For example, the designated areas can represent expected locations of the rails, edges, sides, or the like, of the route prior to obtaining the image data. With respect to rails of a track, the rails may be properly aligned when the rails are in the same locations as when the rails were installed or last passed an inspection of the locations of the rails, or at least within a designated tolerance. This designated tolerance can represent a range of locations that the rails, edges, sides, or the like, may appear in the image data due to rocking or other movements of the robotic system.

Optionally, the benchmark visual profile may represent a former image of the route obtained by a visual acquisition device on the same or a different robotic system. For example, the benchmark visual profile may be an image or image data obtained from a visual acquisition device onboard the robotic system and the environmental information proximate acquired by a visual acquisition device disposed off-board the robotic system can be compared to the benchmark visual profile. The designated areas can represent the locations of the pixels in the former image that have been identified as representing components of the route (e.g., rails, edges, sides, or the like, of the route).

In one aspect, the image analysis processor can map the pixels representative of components of the route to the benchmark visual profile or can map the designated areas of the benchmark visual profile to the pixels representative of the route. This mapping may include determining if the locations of the pixels representative of the components of the route in the image are in the same locations as the designated areas of the benchmark visual profile.

FIGS. 10 and 11 illustrate different views of a visual mapping diagram 1900 of the image data and the benchmark visual profile according to one example of the inventive subject matter described herein. The mapping diagram represents one example of a comparison of the image with the benchmark visual profile that is performed by the image analysis processor disposed onboard the robotic system. As shown in the mapping diagram, the designated areas of the benchmark visual profile can be overlaid onto the image data. The image analysis processor can then identify differences between the image data and the benchmark visual profile. For example, the image analysis processor can determine whether the pixels representing the components of the route are disposed outside of the designated areas in the benchmark visual profile. Optionally, the image analysis processor can determine if locations of the pixels representing the components of the route in the image data (e.g., coordinates of these pixels) are not located within the designated areas (e.g., are not coordinates located within outer boundaries of the designated areas in the benchmark visual profile).

If the image analysis processor determines that at least a designated amount of the pixels representing one or more components of the route are outside of the designated areas in the benchmark visual profile, then the image analysis processor can identify the segment of the route that is shown in the image data as being misaligned. For example, the image analysis processor can identify groups 1902, 1904, 1906 of the pixels 1702 that represent one or more components of route as being outside of the designated areas. If the number, fraction, percentage, or other measurement of the pixels that are representative of the components of the route and that are outside the designated areas exceeds a designated threshold (e.g., 10%, 20%, 30%, or another amount), then the segment of the route shown in the image data is identified as representing a hazard or obstacle (e.g., the route is misaligned, bent, or otherwise damaged). On the other hand, if the number, fraction, percentage, or other measurement of the pixels that are representative of components the route and that are outside the designated areas does not exceed the threshold, then the segment of the route shown in the image data is not identified as representing a hazard or obstacle.

FIG. 12 illustrates image data 2000 generated by one or more visual acquisition devices disposed onboard the robotic system and benchmark visual profiles 2002, 2004 of the route according to another embodiment. The benchmark visual profiles can be created by the image analysis processor from the image data. For example, the image analysis processor can examine intensities of the pixels in the image data to determine the location of the route, as described above. Within the location of the route in the image data, the image analysis processor can find two or more pixels having the same or similar (e.g., within a designated range of each other) intensities. Optionally, the image analysis processor may identify many more pixels with the same or similar intensities. The benchmark visual profiles therefore may be determined without having the profiles previously created and/or stored in a memory.

The image analysis processor then determines a relationship between these pixels. For example, the image analysis processor may identify a line between the pixels in the image for each rail, side, edge, or other component or the route. These lines can represent the benchmark visual profiles shown in FIG. 12. The image analysis processor can then determine if other pixels representative of the components of the route are on or within the benchmark visual profiles (e.g., within a designated distance of the benchmark visual profiles), or if these pixels are outside of the benchmark visual profiles. In the illustrated example, most or all of the pixels representative of the rails of the route are on or within the benchmark visual profiles.

FIG. 13 illustrates other image data with benchmark visual profiles 2104, 2106 of the route according to another embodiment. The benchmark visual profiles 2104, 2106 may be created using the image data obtained by one or more visual acquisition devices disposed onboard the robotic system, as described above in connection with FIG. 12. In contrast to the image data shown in FIG. 12, however, the image data 2100 shown in FIG. 13 shows a segment 2106 of the route that does not fall on or within a benchmark visual profile 2102. This segment 2106 curves outward and away from the benchmark visual profile. The image analysis processor can identify this segment 2106 because the pixels having intensities that represent the components of the route are no longer on or in the benchmark visual profile. Therefore, the image analysis processor can identify the segment 2106 as an obstacle that the robotic system is traveling toward.

In one aspect, the image analysis processor can use a combination of techniques described herein for examining the route. For example, if both rails of the route are bent or misaligned from previous positions, but are still parallel or substantially parallel to each other, then the gauge distance between the rails may remain the same or substantially the same, and/or may not substantially differ from the designated gauge distance of the route. As a result, only looking at the gauge distance in the image data may result in the image analysis processor failing to identify damage (e.g., bending) to the rails. In order to avoid this situation, the image analysis processor additionally or alternatively can generate the benchmark visual profiles using the image data and compare these profiles to the image data of the rails, as described above. Bending or other misalignment of the rails may then be identified when the bending in the rails deviates from the benchmark visual profile created from the image data.

In one embodiment, responsive to the image analysis processor determining that the image data represents an upcoming obstacle on the route, the image analysis processor may direct generate a warning signal to notify the operator of the robotic system of the upcoming obstacle. For example, the image analysis processor can direct the control unit of the robotic system to display a warning message and/or display the image data. The robotic system then may move through the safe braking distance described above to make a decision as to whether to ignore the warning or to stop movement of the robotic system. If the obstacle is detected within the safe braking distance based on the image data obtained from one or more visual acquisition devices disposed onboard the robotic system, then the robotic system may be notified by the image analysis processor of the obstacle, thereby allowing reaction time to try and mitigate the obstacle, such as by stopping or slowing movement of the robotic system.

The image analysis system can receive image data from one or more visual acquisition devices disposed onboard one or more robotic systems, convert the image data into wireframe model data, and examine changes in the wireframe model data over time and/or compare wireframe model data from image data obtained by different visual acquisition to identify obstacles in the route, predict when the route will need maintenance and/or repair, etc. The image data can be converted into the wireframe model data by identifying pixels or other locations in the image data that are representative of the same or common edges, surfaces, or the like, of objects in the image data. The pixels or other locations in the image data that represent the same objects, surfaces, edges, or the like, may be identified by the image analysis system by determining which pixels or other locations in the image data have similar image characteristics and associating those pixels or other locations having the same or similar image characteristics with each other.

The image characteristics can include the colors, intensities, luminance, locations, or other information of the pixels or locations in the image data. Those pixels or locations in the image data having colors (e.g., wavelengths), intensities, and/or luminance that are within a designated range of each other and/or that are within a designated distance from each other in the image data may be associated with each other by the image analysis system. The image analysis system can group these pixels or locations with each other because the pixels or locations in the image data likely represent the same object (e.g., a rail of a track being traveled by a rail vehicle, sides of a road, or the like).

The pixels or other locations that are associated with each other can be used to create a wireframe model of the image data, such as an image that represents the associated pixels or locations with lines of the same or similar colors, and other pixels or location with a different color. The image analysis system can generate different wireframe models of the same segment of a route from different sets of image data acquired by different visual acquisition devices and/or at different times. The image analysis system can compare these different wireframe models and, depending on the differences between the wireframe models that are identified, identify and/or predict obstacles and whether the articulable arm may be needed to manipulate the target.

In one aspect, the image analysis system may have different predicted amounts of difficulty surmount an obstacle on the route associated with different changes in the wireframe data. For example, detection of a bend or other misalignment in the route based on changes in the wireframe model data may be associated with more damage to the route than other types of changes in the wireframe model data. As another example, the changing of a solid line in earlier wireframe model data to a segmented line in later wireframe model data can be associated with different degrees of damage to the route based on the number of segments in the segmented line, the size of the segments and/or gaps between the segments in the segmented line, the frequency of the segments and/or gaps, or the like. Based on the degree of damage identified from changes in the wireframe model data, the image analysis system may automatically re-route or stop the robotic system.

FIG. 14 illustrates a flowchart of one embodiment of a method 2200 for identifying route-related obstacles. The method may be practiced by one or more embodiments of the systems described herein. At 2202, image data is obtained using one or more visual acquisition devices. As described above, portable visual acquisition devices may be coupled to or otherwise disposed onboard one or more off-board devices located remote from a robotic system that moves along a route. Suitable off-board devices may include stationary wayside device, a mobile land-based device, and/or an aerial device. The image data represents a segment of the route that is adjacent to the robotic system. For example, the segment may be in front of or behind the robotic system. In one embodiment, the wayside device may be located at a front of the robotic system and the aerial device may fly ahead of the robotic system along a direction of travel in order to capture images and/or video of portions of the route being traveled by the robotic system ahead of the robotic system.

At 2204, the image data may be communicated to the robotic system from the off-board device. For example, the image data may be communicated to a transportation system receiver on the robotic system. The image data can be wirelessly communicated. The image data can be communicated as the image data is obtained, or may be communicated responsive to the robotic system entering into or leaving a designated area, such as a geofence. For example, the visual acquisition device on the wayside device may communicate image data to the robotic system upon the robotic system entering a communication range of a communication device of the visual acquisition device and/or upon the wayside device receiving a data transmission request from the robotic system. In an embodiment in which the aerial device leads or trails the robotic system, the image data from the visual acquisition device may be communicated continuously or at least periodically as the image data is obtained and the robotic system moves along the route.

At 2206, the image data is examined for one or more purposes. These purposes may be to control or limit control of the robotic system, to control operation of the visual acquisition device, to identify damage to the robotic system, to assess the route ahead of the robotic system, to assess the space between the arm and the target, and the like, and/or to identify obstacles in the way of the robotic system. The image data may be used to generate environmental information, and optionally an environmental model. This may be useful in selecting a movement plan for the arm to contact the target.

Further, in one embodiment, if the visual acquisition device is disposed onboard an aerial device flying ahead of the robotic system, then the image data can be analyzed to determine whether an obstacle exists ahead of the robotic system along the direction of travel of the robotic system and/or between the arm and the target. The image data may be examined using one or more image analysis processors onboard the robotic system and/or onboard the aerial device. For example, in an embodiment, the aerial device includes the one or more image analysis processors, and, responsive to identifying an obstacle in an upcoming segment of the route, the aerial device can communicate a warning signal and/or a control signal to the robotic system in the form of environmental information. The warning signal may notify an operator or controller of the robotic system of the obstacle. The control signal can interact with a vehicle control system, such as a Positive Train Control (PTC) system to automatically or autonomously slow the movement of the robotic system or even bring it to a stop. The robotic system's propulsion and navigation systems may maneuver the robotic system around the obstacle to arrive near enough to the target that the arm can be moved into contact therewith.

An image analysis system can examine the image data and, if it is determined that one or more obstacles are disposed ahead of the robotic system, then the image analysis system can generate a warning or control signal that is communicated to the control unit of the robotic system. This signal can be received by the control unit and, responsive to receipt of this control signal, the control unit can slow or prevent movement of the robotic system. For example, the control unit may disregard movement of controls by an onboard operator to move the robotic system, the control unit may engage brakes and/or disengage a propulsion system of the robotic system (e.g., turn off or otherwise deactivate an engine, motor, or other propulsion-generating component of the robotic system). In one aspect, the image analysis system can examine the image data to determine if the route is damaged (e.g., the rails on which a robotic system is traveling are broken, bent, or otherwise damaged), if obstacles are on the route ahead of the robotic system (e.g., there is another robotic system or object on the route), if the switches or signals at an intersection are operating properly, and the like.

Optionally, the method may include controlling the aerial device to fly relative to the robotic system. For example, the aerial device may be controlled to fly a designated distance from the robotic system along a path of the route such that the aerial device maintains the designated distance from the robotic system as the robotic system moves along the route. In another example, the aerial device may be controlled to fly to a designated location along the route ahead of the robotic system and to remain stationary in the air at the designated location for a period of time as the robotic system approaches the designated location.

One or more embodiments herein are directed to providing image data of a route to a robotic system on the route from a mobile platform or a fixed platform remote from the robotic system to enhance the awareness and information available to the operator of the robotic system. The mobile platform may be an aerial device that flies above the route, such as a quad rotor robot that is assigned to the robotic system. The aerial device is controlled by the crew or controller of the robotic system, such as to maintain a specified distance ahead of the robotic system, to travel to a specified location ahead of the robotic system, to maintain a specified height above the route, to use a specified sensor (e.g., infrared camera versus a camera in the visible wavelength spectrum) to capture the image data, and the like. The aerial device may be able to follow a path of the route based on known features of the route in order to provide idealized viewing points (which could be modified by the controller or the crew during the flight of the aerial device). The aerial device may dock on the robotic system, and the aerial device may return to the device for recharging automatically in response to a battery level falling below a designated threshold.

A suitable fixed platform may include permanent wayside equipment. For example, each grade crossing and/or other designated locations along the route could include the visual acquisition device that captures image data of the route used to detect obstacles. The image data from each visual acquisition device could become automatically accessible to the crew of a robotic system on the route as the robotic system enters a determined or predefined range of the wayside equipment (e.g. within directional Wi-Fi distance, within stopping distance plus some margin of error, etc.).

Optionally, the aerial devices and/or wayside devices that hold the visual acquisition devices may include onboard processing capability (e.g., one or more processors) that may be configured to detect anomalies in the captured segments of the route. The aerial devices and/or wayside devices may be configured to send notifications to the associated robotic system, to other nearby, non-associated robotic systems on the route, to a dispatch location, or the like. Furthermore, the aerial devices and/or wayside devices may include two-way audio capability such that the devices may provide audible warnings of the approaching robotic system on the route, such as at a route crossing. In addition, the aerial devices and/or wayside devices may allow the operator and/or crew of the associated robotic system to communicate, via the aerial device or wayside device, potential obstacles to other nearby robotic systems on the route in the form of still images, video, audio messages, text messages, or the like.

In one embodiment, a system (e.g., an off-board camera system) includes a camera and a communication device. The camera is configured to be disposed on an off-board device remotely located from a robotic system as the robotic system moves along a route. The camera is configured to generate image data representative of an upcoming segment of the route relative to a direction of travel of the robotic system. The communication device is configured to be disposed on the off-board device and to wirelessly communicate the image data to the robotic system during movement of the robotic system along the route.

A processing unit, processor, or computer that is “configured to” perform a task or operation may be particularly structured or programmed to perform the task or operation (e.g., having one or more programs or instructions stored thereon or used in conjunction therewith tailored or intended to perform the task or operation, and/or having an arrangement of processing circuitry tailored or intended to perform the task or operation).

As used herein, the term “computer,” “controller,” and “module” may each include any processor-based or microprocessor-based system including systems using microcontrollers, reduced instruction set computers (RISC), application specific integrated circuits (ASICs), logic circuits, GPUs, FPGAs, and any other circuit or processor capable of executing the functions described herein. The above examples are exemplary only, and are thus not intended to limit in any way the definition and/or meaning of the term “module” or “computer.” Embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optic drive, and the like. The storage device may be other similar means for loading computer programs or other instructions into the computer or processor. The computer, module, or processor executes a set of instructions that are stored in one or more storage elements, in order to process input data. The storage elements may also store data or other information as desired or needed. The storage element may be in the form of an information source or a physical memory element within a processing machine.

Various embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, any programs may be stand-alone programs, may be incorporated as subroutines in an operating system, may be functions in an installed software package, and the like. The various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. The modules or units shown in the attached figures may represent the hardware that operates based on software or hardwired instructions, the software that directs hardware to perform the operations, or a combination thereof. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The set of instructions may include various commands that instruct the computer, module, or processor as a processing machine to perform specific operations such as the methods and processes of the various embodiments described and/or illustrated herein. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program. The individual components of the various embodiments may be virtualized and hosted by a cloud type computational environment, for example to allow for dynamic allocation of computational power, without requiring the user concerning the location, configuration, and/or specific hardware of the computer system.

The above description is illustrative and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those of ordinary skill in the relevant art. Such other examples are intended to be within the scope of the claims if the examples have structural elements that do not differ from the literal language of the claims, or the examples include equivalent structural elements with insubstantial differences from the literal language of the claims.

What is claimed is:

1. A robotic system comprising:
an articulable arm extending from a base and configured to be movable toward a target;
a visual acquisition unit configured to be mounted to the arm or the base and to acquire image data; and
a controller operably coupled to the arm and the visual acquisition unit, and configured to derive environmental information from the image data, the environmental information corresponding to at least one of the arm or the target, the controller also configured to generate at least one planning scheme using the environmental information to translate the arm toward the target, to select at least one planning scheme for implementation, and to control movement of the arm toward the target using the at least one selected planning scheme.

2. The robotic system of claim 1, wherein the controller is further configured to:
control the visual acquisition unit to acquire additional image data during movement of the arm;
generate additional environmental information from the additional image data; and
re-plan movement of the arm based at least in part on the additional environmental information.

3. The robotic system of claim 2, wherein the controller is further configured to use a first planning scheme for an initial planned movement using the image data, and to use a second planning scheme that is different from the first planning scheme for a revised planned movement using the additional environmental information.

4. The robotic system of claim 1, wherein the controller is further configured to control the movement of the arm in a series of stages, wherein the selected at least one planning scheme includes a first planning scheme for at least one of the stages and a second planning scheme that is different from the first planning scheme for at least one other of the stages.

5. The robotic system of claim 1, further comprising a propulsion system supported by the base, and configured to propel the base toward the target.

6. The robotic system of claim 5, wherein the controller is further configured to identify a route from a present location of the arm toward the target, to control the propulsion system along the route to a determined location adjacent the target, and to move the arm to the target.

7. The robotic system of claim 6, wherein the controller is further configured to identify an obstacle on the route based at least in part on the image data.

8. The robotic system of claim 7, wherein the controller is further configured to re-route the arm in response to identification of an obstacle based at least in part on the image data obtained by the visual acquisition unit.

9. The robotic system of claim 5, wherein the controller is further configured to use environmental information from the visual acquisition unit to position the base to facilitate the arm moving to contact the target.

10. The robotic system of claim 9, wherein the arm is configured to manipulate the target and thereby to actuate the target.

11. The robotic system of claim 10, wherein the arm is configured to grasp and actuate a lever.

12. The robotic system of claim 9, wherein the arm comprises a sensor configured to sense or detect position and/or motion of the arm (or portions thereof) at a joint and to provide feedback to the controller.

13. The robotic system of claim 9, wherein the arm comprises at least one sensor disposed at a distal end of the arm from the base.

14. The robotic system of claim 13, wherein the sensor is a microswitch operable to be triggered when the distal end of the arm contacts the target.

15. The robotic system of claim 13, wherein the sensor comprises a magnetometer configured to sense a presence and/or proximity of the sensor relative to a ferro metallic material.

16. The robotic system of claim 6, wherein the controller is further configured to stop or slow the robotic system in response to detecting an obstacle on a route to the target.

17. The robotic system of claim 16, wherein the controller is further configured to communicate detection of an obstacle on a route to other vehicles, to an off-board back office system, or to both.

18. A method, comprising:
acquiring image data;
deriving environmental information corresponding to at least one of an articulable arm or a target from the image data;
generating a planning scheme using the derived environmental information; and
controlling movement of an arm toward a target using the planning scheme.

19. The method of claim 18, further comprising:
acquiring additional image data during movement of the arm;
generating additional environmental information from the additional image data;
generating additional planning schemes for movement of the arm based at least in part on the additional environmental information; and
moving a body supporting the arm towards the target based at least in part on the environmental information, the additional environmental information, or both.

20. A robotic system comprising:
an articulable arm extending from a base and configured to be movable toward a target;
a visual acquisition unit configured to be mounted to the arm or the base and to acquire image data; and
a controller operably coupled to the arm and the visual acquisition unit and configured to:
derive, from the image data, environmental information corresponding to at least one of the arm or the target,
generate at least one planning scheme using the environmental information to translate the arm toward the target, wherein each planning scheme is defined by at least one of path shape or path type,
select at least one planning scheme for implementation based at least in part on the planning scheme providing movement of the arm in a determined time frame or at a determined speed, and
control movement of the arm toward the target using the at least one selected planning scheme.
